(19) United States
(12) Patent Application Publication
(10) Pub. No.: US 2025/0233178 A1
(43) Pub. Date: Jul. 17, 2025

(54) FUEL CELL SYSTEM

(71) Applicant: AISAN KOGYO KABUSHIKI KAISHA, Obu-shi, Aichi-ken (JP)

(72) Inventors: Kazunori ITO, Nagoya-shi (JP); Hirokazu ANDO, Toyoake-shi (JP); Yuki FUJITA, Mizuho-shi (JP)

(73) Assignee: AISAN KOGYO KABUSHIKI KAISHA, Obu-shi, Aichi-ken (JP)

(21) Appl. No.: 18/848,742

(22) PCT Filed: Mar. 7, 2023
(86) PCT No.: PCT/JP2023/008581

§ 371 Date: Sep. 19, 2024

(30) Foreign Application Priority Data
Apr. 15, 2022 (JP) 2022-067361

(51) Int. Cl. H01M 8/04746; H01M 8/04082; H01M 8/04089

(52) U.S. Cl. CPC H01M 8/04753; H01M 8/04097; H01M 8/04201

(57) ABSTRACT

A fuel cell system wherein a fuel supply unit is driven by pulse control when a required supply flow rate of fuel to a fuel cell is less than a flow rate at maximum circulation efficiency at which the circulation efficiency of an ejector is the maximum value when the fuel supply unit is driven by proportional control, and the fuel supply unit is driven by the proportional control when the required supply flow rate of the fuel to the fuel cell is greater than or equal to the flow rate at the maximum circulation efficiency.

### TECHNICAL FIELD

The disclosure relates to a fuel cell system.

### BACKGROUND ART

Patent Document 1 discloses a fuel cell system includes an ejector (a jet pump) for circulating off-gas, which is unused fuel discharged from a fuel cell, into a fuel supply passage (a hydrogen supply line). In this fuel cell system disclosed in Patent document 1, a fuel supply device (a solenoid valve) is driven by pulse control when the internal pressure of the fuel cell is less than a predetermined pressure and is driven by proportional control when the internal pressure of the fuel cell is the predetermined pressure or higher. This is intended to improve the circulation efficiency of the ejector (recirculation gas suction performance) during low output power driving of the fuel cell system, during which the supply flow rate of fuel to the fuel cell is low.

### RELATED ART DOCUMENTS

### Patent Documents

Patent Document 1: Japanese unexamined patent application publication No. 2012-255429

### SUMMARY OF INVENTION

### Problems to be Solved by the Invention

In the fuel cell system disclosed in Patent Document 1, as described above, the timing of switching the driving mode of the fuel supply device between the pulse control and the proportional control is determined based on the internal pressure of the fuel cell. However, the supply flow rate of fuel to the fuel cell is not constant with respect to the internal pressure of the fuel cell, and therefore it may not improve the circulation efficiency of the ejector during the low output power driving of the fuel cell system, which supplies fuel to the fuel cell at a low flow rate.

The present disclosure has been made to address the above problems and has a purpose to provide a fuel cell system capable of improving the circulation efficiency of an ejector.

### Means of Solving the Problems

To achieve the above-mentioned purpose, one aspect of the disclosure provides a fuel cell system including: a fuel cell; a fuel supply passage for supplying fuel to the fuel cell; an ejector provided in the fuel supply passage; a fuel supply unit for supplying the fuel to the ejector; and a circulation passage for circulating the fuel that is unused in and discharged from the fuel cell to the ejector, the fuel cell system being configured to supply the fuel to the fuel cell through the fuel supply passage via the ejector, wherein the fuel cell system is configured to: drive the fuel supply unit by pulse control when a required supply flow rate of the fuel for the fuel cell is smaller than a flow rate determined at a maximum circulation efficiency at which a circulation efficiency of the ejector is a maximum value when the fuel supply unit is driven by proportional control; and drive the fuel supply unit by the proportional control when the required supply flow rate of the fuel for the fuel cell is equal to or larger than the flow rate determined at the maximum circulation efficiency.

Herein, when a supply flow rate of fuel required for the fuel cell is small, a flow rate of fuel supplied from the fuel supply unit to the ejector is small and hence the flow velocity of the fuel in the ejector is apt to be slow, so that the circulation efficiency of the ejector tends to be low. The circulation efficiency of an ejector indicates the circulation performance of off-gas (i.e., fuel not used in the fuel cell) to the ejector.

Therefore, according to the above-described aspect, when the supply flow rate of fuel required for the fuel cell is equal to or less than the flow rate determined at the maximum circulation efficiency, the fuel supply unit is driven by the pulse control to intermittently supply fuel from the fuel supply unit to the ejector, thus enabling to increase the flow velocity of the fuel supplied to the ejector. This can increase the circulation flow rate of off-gas to the ejector and thus the circulation efficiency of the ejector can be improved.

In the above-described aspect, preferably, the ejector includes, as a nozzle for injecting the fuel, a first nozzle; and a second nozzle that can inject the fuel with a larger flow rate than the first nozzle, wherein the fuel supply unit includes: a first fuel supply unit for supplying the fuel to the first nozzle; and a second fuel supply unit for supplying the fuel to the second nozzle, wherein the fuel cell system is configured to: supply the fuel to the fuel cell using the first nozzle in a first supply region until the required supply flow rate of the fuel for the fuel cell reaches or nearly reaches a first flow rate which is a maximum flow rate during use of the first nozzle; and supply the fuel to the fuel cell using the second nozzle in a second supply region where the required supply flow rate of the fuel for the fuel cell is larger than in the first supply region, in the second supply region, drive the second fuel supply unit by the pulse control when the required supply flow rate of the fuel for the fuel cell is smaller than the flow rate at the maximum circulation efficiency, and drive the second fuel supply unit by the proportional control when the required supply flow rate of the fuel for the fuel cell is equal to or larger than the flow rate at the maximum circulation efficiency.

According to this aspect, when the supply flow rate of fuel required for the fuel cell increases and shifts from the first supply region to the second supply region, and the nozzle used in the ejector is switched from the first nozzle to the second nozzle, the second fuel supply unit is driven by the pulse control for a given period of time. Since the second fuel supply unit is driven by the pulse control, the circulation efficiency of the ejector can be improved. This can suppress a reduction in the circulation efficiency of the ejector for a given time after the nozzle used in the ejector is switched from the first nozzle to the second nozzle due to the reduced flow velocity of fuel inside the ejector caused by switching from the first nozzle to the second nozzle.

Another aspect of the disclosure to solve the aforementioned problem provides a fuel cell system including: a fuel cell; a fuel supply passage for supplying fuel to the fuel cell; an ejector provided in the fuel supply passage; and a circulation passage for circulating the fuel that is unused in and discharged from the fuel cell to the ejector, the fuel cell system being configured to supply the fuel to the fuel cell through the fuel supply passage via the ejector, wherein the ejector includes, as a nozzle for injecting the fuel, a first nozzle; and a second nozzle that can inject the fuel with a larger flow rate than the first nozzle, when switching the nozzle used from the first nozzle to the second nozzle, both the first and second nozzles are used for a predetermined time.

This aspect can compensate for a shortage of fuel flow rate at the initial stage when the first nozzle is switched to the second nozzle as the nozzle used in the ejector, and thus the circulation efficiency of the ejector can be improved.

### Effects of the Invention

The fuel cell system of the disclosure can improve the circulation efficiency of an ejector.

### BRIEF DESCRIPTION OF THE DRAWINGS

FIG. 1 is a structure diagram of a fuel cell system in first and second embodiments;

FIG. 2 is a structure diagram of an ejector in the first and second embodiments;

FIG. 3 is a graph showing a relationship between a required supply flow rate and a circulation efficiency of an ejector in the first embodiment;

FIG. 4 is a flowchart showing contents of a control executed in the first embodiment;

FIG. 5 is a flowchart showing how to determine a duty ratio;

FIG. 6 is a correlation chart of an opening degree of a large-flow linear solenoid valve (LSV opening degree) and the required supply flow rate;

FIG. 7 is a time chart showing one example of the control executed in the first embodiment;

FIG. 8 is a flowchart showing contents of a control executed in the second embodiment;

FIG. 9 is a flowchart showing contents of an overlap control;

FIG. 10 is a time chart showing one example of the control executed in the second embodiment; and

FIG. 11 is a graph showing a relationship between a required supply flow rate and a circulation efficiency of an ejector in a related art.

### MODE FOR CARRYING OUT THE INVENTION

An embodiment of a fuel cell system of the disclosure will be described below.

### First Embodiment

A first embodiment will be described first.

### <Overview of Fuel Cell System>

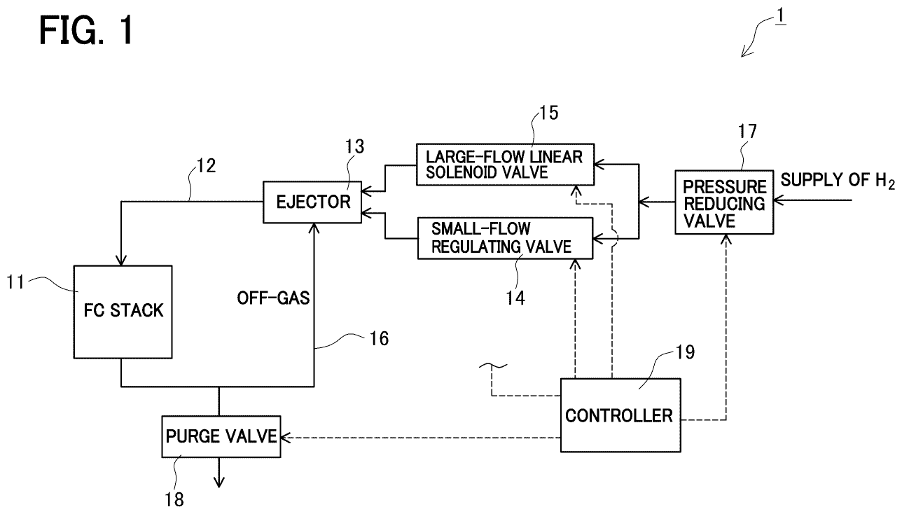

A fuel cell system 1 in the present embodiment includes, as shown in FIG. 1, an FC stack 11, a fuel supply passage 12, an ejector 13, a small-flow regulating valve 14, a large-flow linear solenoid valve 15, a circulation passage 16, a pressure reducing valve 17, a purge valve 18, a controller 19, and others.

The FC stack 11 is a fuel cell that generates power using hydrogen as fuel. The fuel supply passage 12 is a passage through which the fuel (e.g., hydrogen (H₂)) is supplied to the FC stack 11.

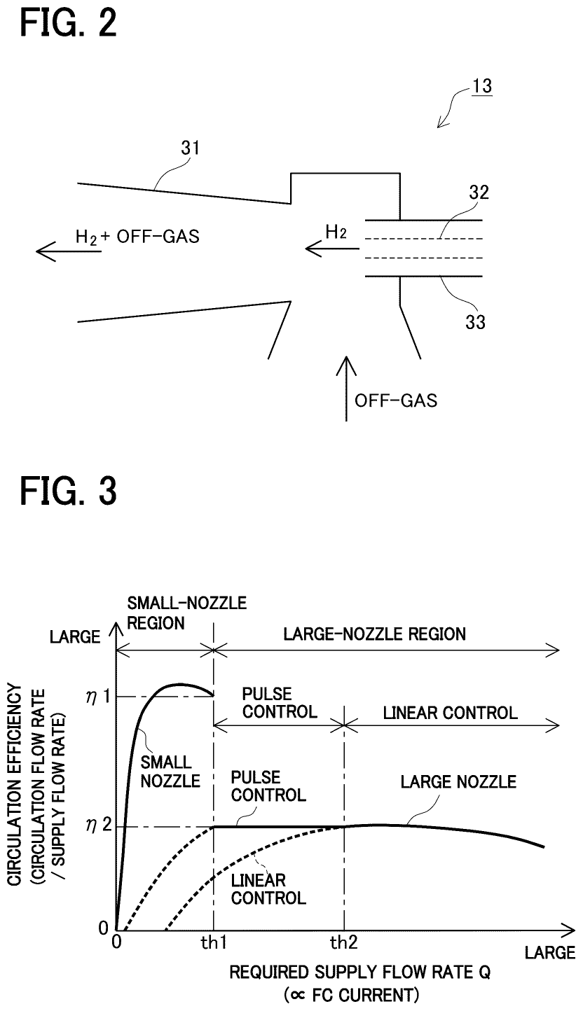

The ejector 13 is provided in the fuel supply passage 12. This ejector 13 is provided with a diffuser 31, and a small nozzle 32 and a large nozzle 33 for injecting fuel, as shown in FIG. 2. The small nozzle 32 has a smaller diameter than the large nozzle 33 and can inject a smaller flow rate of fuel than the large nozzle 33. The large nozzle 33 has a larger diameter than the small nozzle 32 and can inject a larger flow rate of fuel than the small nozzle 32. The small nozzle 32 and the large nozzle 33 are arranged coaxially, i.e., respective central axes coincide with each other, so that the small nozzle 32 is placed inside the large nozzle 33. The small nozzle 32 is one example of a “first nozzle” of the disclosure and the large nozzle 33 is one example of a “second nozzle” of the disclosure.

The ejector 13 configured as above injects fuel through the small nozzle 32 and/or the large nozzle 33 to supply the fuel into the diffuser 31 and also sucks off-gas (that is, unused fuel discharged from the FC stack 11) through the circulation passage 16 by the negative pressure generated in the diffuser 31. Then, the fuel supplied into the diffuser 31 and the off-gas sucked through the circulation passage 16 are supplied together from the ejector 13 to the FC stack 11 through the fuel supply passage 12.

Returning to the description of FIG. 1, the small-flow regulating valve 14 is a fuel supply unit for supplying fuel to the small nozzle 32 of the ejector 13 and regulating a flow rate of the fuel to be supplied to the small nozzle 32. The large-flow linear solenoid valve 15 is a fuel supply unit for supplying fuel to the large nozzle 33 of the ejector 13 and regulating a flow rate of the fuel to be supplied to the large nozzle 33 of the ejector 13. The small-flow regulating valve 14 is one example of a “first fuel supply unit” of the disclosure and the large-flow linear solenoid valve 15 is one example of a “second fuel supply unit” of the disclosure.

The circulation passage 16 is a passage for circulating the off-gas discharged from the FC stack 11 to the ejector 13.

The pressure reducing valve 17 is a valve for reducing the pressure of a high-pressure fuel supplied from a fuel tank (not shown). The purge valve 18 is a valve that is connected to the circulation passage 16 and will be opened to discharge out excess fuel that could not be consumed in the FC stack 11, that is, excess off-gas.

The controller 19 is an ECU that is provided with for example a central processing unit (CPU), various memories, and others, and controls the entire fuel cell system 1. Specifically, the controller 19 controls the small-flow regulating valve 14, large-flow linear solenoid valve 15, pressure reducing valve 17, purge valve 18, and others.

In the fuel cell system 1 configured as above, the pressure of the high-pressure fuel supplied from the fuel tank is reduced by the pressure reducing valve 17, the flow rate of this fuel is then regulated by the small-flow regulating valve 14 and the large-flow linear solenoid valve 15 and supplied to the ejector 13, and thereafter the fuel is supplied via the ejector 13 to the FC stack 11 through the fuel supply passage 12.

### <Control in Large-Nozzle Region>

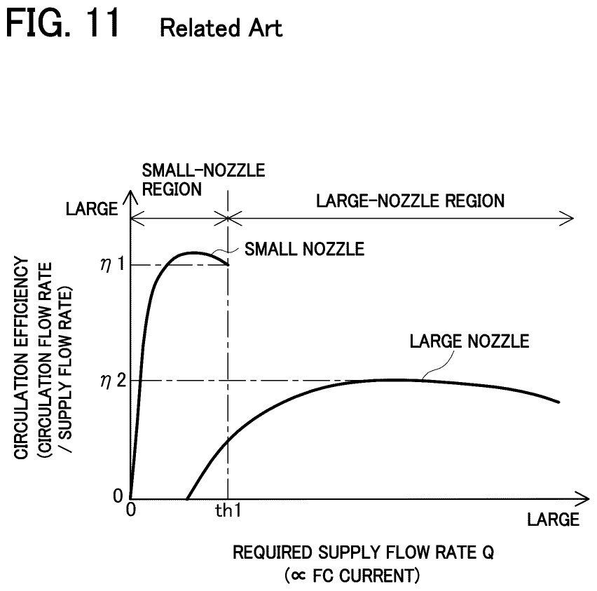

Conventionally, as shown in FIG. 11, until a required supply flow rate Q, which is a supply flow rate of fuel required for the FC stack 11, gradually increases from zero and reaches a first flow rate th1 that is the maximum flow rate during use of the small nozzle 32, the fuel is supplied to the FC stack 11 through the fuel supply passage 12 via the ejector 13 using the small nozzle 32. Then, when the required supply flow rate Q exceeds the first flow rate th1, the fuel is supplied to the FC stack 11 through the fuel supply passage 12 via the ejector 13 using the large nozzle 33. In this conventional manner, when the required supply flow rate Q exceeds the first flow rate th1, the nozzle used in the ejector 13 is switched from the small nozzle 32 to the large nozzle 33.

However, the circulation efficiency of the ejector 13 is significantly lower during use of the large nozzle 33 than during use of the small nozzle 32, as shown in FIG. 11. Therefore, when the nozzle used in the ejector 13 is switched from the small nozzle 32 to the large nozzle 33 immediately when the required supply flow rate Q becomes larger than the first flow rate th1, the circulation efficiency of the ejector 13 is largely reduced. Consequently, the circulation flow rate of off-gas to the ejector 13 greatly becomes smaller, resulting in a decreased flow rate of fuel to be supplied via the ejector 13 to the FC stack 11 through the fuel supply passage 12, and thus a required flow rate of fuel may not be supplied to the FC stack 11.

Herein, the circulation efficiency of the ejector 13 represents the circulation performance of off-gas to the ejector 13 and is the ratio of a flow rate of off-gas circulated to the ejector 13 with respect to a flow rate of fuel supplied to the FC stack 11 (i.e., a flow rate of fuel discharged from the ejector 13), and is represented by the following expression.

$$( Circulation efficiency of ejector 13 ) = ( Circulation flow rate of off - gas to ejector 13 ) / ( Supply flow rate of fuel to FC stack 11 ) \qquad ( Expression 1 )$$

In the present embodiment, in the large-nozzle region, the controller 19 switches the driving mode for the large-flow linear solenoid valve 15 between the pulse control and the linear control, as shown in FIG. 3. Specifically, when the required supply flow rate Q is less than the second flow rate th2, the controller 19 drives the large-flow linear solenoid valve 15 by the pulse control (i.e., duty ratio control). When the required supply flow rate Q is equal to or larger than the second flow rate th2, the controller 19 drives the large-flow linear solenoid valve 15 linearly (i.e., by proportional control).

Specifically, when the required supply flow rate Q increases and shifts from the small-nozzle region to the large-nozzle region, the nozzle used in the ejector 13 is switched from the small nozzle 32 to the large nozzle 33. However, until the required supply flow rate Q reaches the second flow rate th2, the controller 19 drives the large-flow linear solenoid valve 15 by the pulse control. Thereafter, the controller 19 drives the large-flow linear solenoid valve 15 by linear control. The small-nozzle region is one example of a “first supply region” of the disclosure and the large-nozzle region is one example of a “second supply region” of the disclosure.

Herein, the second flow rate th2 is a supply flow rate of fuel supplied to the FC stack 11 when the circulation efficiency of the ejector 13 using the large nozzle 33 is a maximum value n2 while the large-flow linear solenoid valve 15 is driven by the linear control. The second flow rate th2 is one example of a “flow rate at a maximum circulation efficiency” of the disclosure. In FIG. 3, the value n1 is a value of the circulation efficiency of the ejector 13 when the required supply flow rate Q is the first flow rate th1.

When the required supply flow rate Q shifts from the small-nozzle region to the large-nozzle region and the nozzle used in the ejector 13 is switched from the small nozzle 32 to the large nozzle 33, the large-flow linear solenoid valve 15 is subsequently driven by the pulse control for a given time. When the large-flow linear solenoid valve 15 is driven by the pulse control in the above manner, the fuel is fed intermittently, increasing the fuel flow velocity, and thus the pressure of sucking off-gas is raised. This results in an increased circulation flow rate of off-gas to the ejector 13 and hence can improve the circulation efficiency of the ejector 13. Consequently, for a given time after switching the nozzle used in the ejector 13 from the small nozzle 32 to the large nozzle 33, it is possible to suppress a decrease in the fuel flow velocity in the ejector 13 due to switching from the small nozzle 32 to the large nozzle 33 and thus suppress a reduction in the circulation efficiency of the ejector 13.

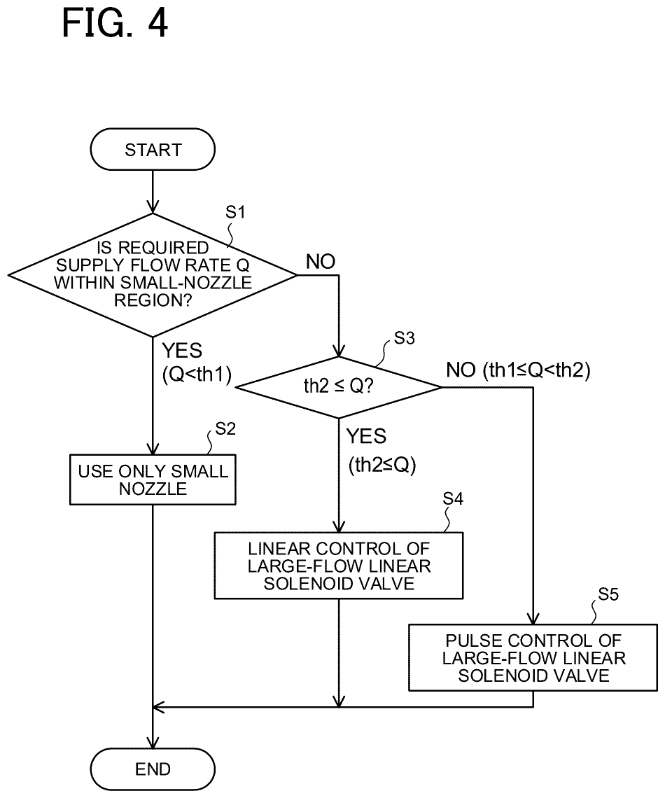

In the present embodiment, specifically, the controller 19 executes the control whose details are described in FIG. 4. As shown in FIG. 4, the controller 19 first determines whether or not the required supply flow rate Q is within the small-nozzle region (that is, Q<th1) (step S1).

When the required supply flow rate Q is within the small-nozzle region (step S1: YES), the controller 19 uses only the small nozzle 32 (step S2). In this way, in the small-nozzle region until the required supply flow rate Q reaches or nearly reaches the first flow rate th1 which is the maximum flow rate during use of the small nozzle 32, the controller 19 supplies the fuel to the FC stack 11 through the fuel supply passage 12 via the ejector 13 using the small nozzle 32 while regulating the flow rate of fuel to be supplied to the small nozzle 32 by the small-flow regulating valve 14.

In the large-nozzle region where the required supply flow rate Q is larger than the small-nozzle region, the controller 19 supplies fuel to the FC stack 11 through the fuel supply passage 12 via the ejector 13 using the large-flow linear solenoid valve 15 while regulating the flow rate of fuel to be supplied to the large nozzle 33 by the large-flow linear solenoid valve 15.

Specifically, when the required supply flow rate Q is not within the small-nozzle region (step S1: NO), the controller 19 determines whether or not the required supply flow rate Q is equal to or larger than the second flow rate th2 (step S3).

When the required supply flow rate Q is the second flow rate th2 or more (step S3: YES), the controller 19 drives the large-flow linear solenoid valve 15 by the linear control (step S4).

On the other hand, when the required supply flow rate Q is less than the second flow rate th2 (step S3: NO), that is, when the required supply flow rate Q is the first flow rate th1 or more and less than the second flow rate th2, the controller 19 drives the large-flow linear solenoid valve 15 by the pulse control (step S5).

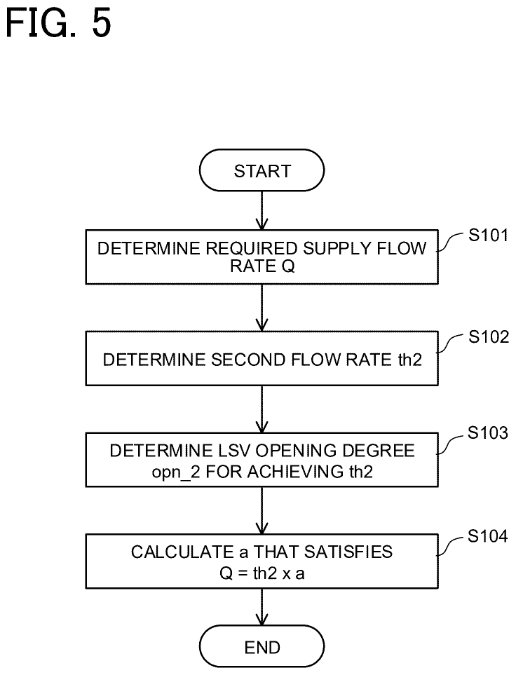

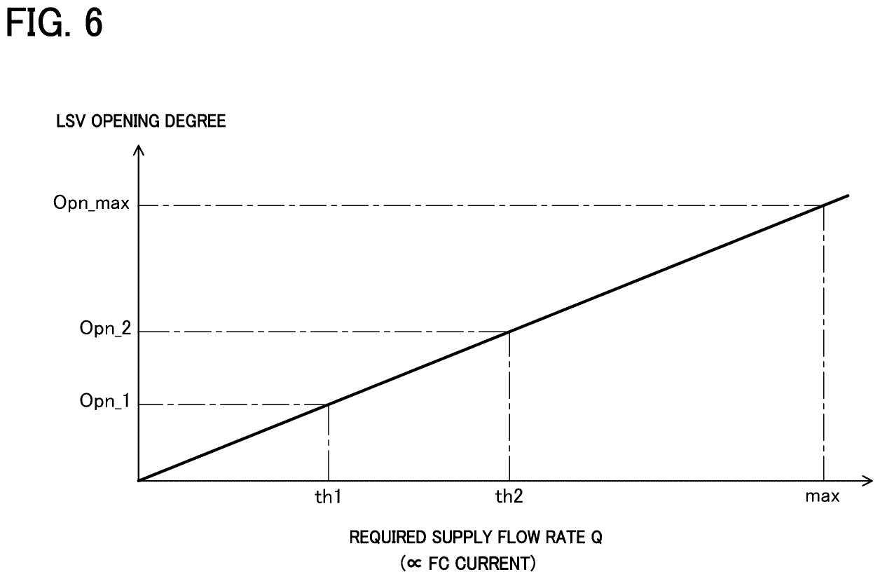

Herein, the duty ratio a for driving the large-flow linear solenoid valve 15 by the pulse control is determined as described in FIG. 5. As shown in FIG. 5, the controller 19 determines the required supply flow rate Q (step S101), and determines the second flow rate th2 (step S102). The controller 19 then determines the opening degree opn_2 of the large-flow linear solenoid valve 15 to achieve the second flow rate th2 based on a correlation chart shown in FIG. 6 (step S103). The controller 19 subsequently calculates the duty ratio a that satisfies: Q=th2×a (step S104).

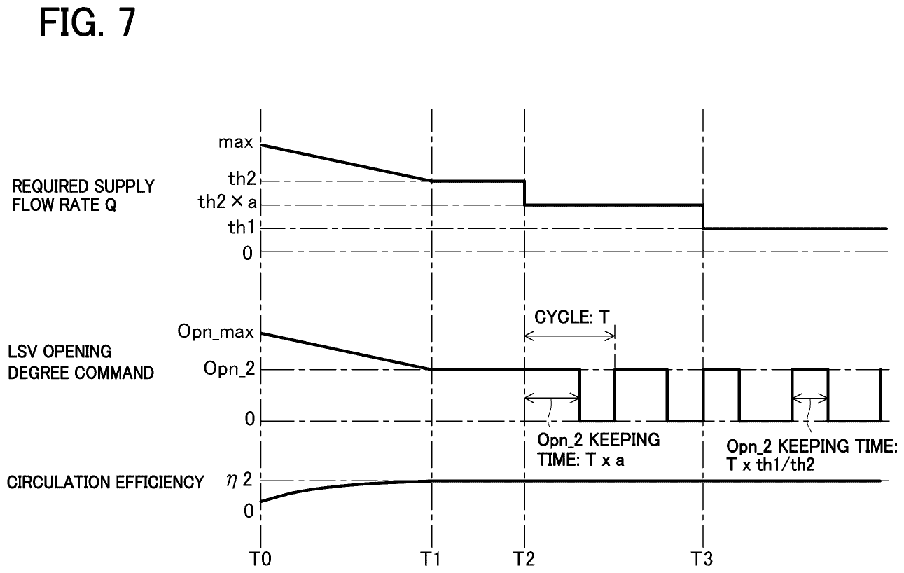

By executing the controls shown in FIG. 4 to FIG. 6, for example, the control shown in a time chart of FIG. 7 is performed as one example. As shown in FIG. 7, when the required supply flow rate Q is the second flow rate th2 or more (time T0 to time T2), the large-flow linear solenoid valve 15 is driven under the linear control.

When the required supply flow rate Q is equal to “flow rate th2×a” (a is larger than 0 and less than 1), that is, when the required supply flow rate Q is larger than the first flow rate th1 and smaller than the second flow rate th2 (time T2 to time T3), the large-flow linear solenoid valve 15 is driven by the pulse control at the duty ratio a.

When the required supply flow rate Q is the first flow rate th1 (time T3 and subsequent), the large-flow linear solenoid valve 15 is driven by the pulse control at a duty ratio of (th1/th2).

### Operations and Effects of Embodiment

In the fuel cell system 1 in the present embodiment, as described above, in the large-nozzle region, the controller 19 drives the large-flow linear solenoid valve 15 by the pulse control when the required supply flow rate Q is the second flow rate th2 or less and drives the large-flow linear solenoid valve 15 by the linear control when the required supply flow rate Q is larger than the second flow rate th2.

When the required supply flow rate Q shifts from the small-nozzle region to the large-nozzle region and the nozzle used in the ejector 13 is switched from the small nozzle 32 to the large nozzle 33, the large-flow linear solenoid valve 15 is subsequently driven by the pulse control for a given time, as described above. Driving the large-flow linear solenoid valve 15 by the pulse control enables to enhance the circulation efficiency of the ejector 13. During the given time after switching the nozzle used in the ejector 13 from the small nozzle 32 to the large nozzle 33, it is possible to suppress a decrease in the fluid flow velocity in the ejector 13 due to switching from the small nozzle 32 to the large nozzle 33, and thus suppress a reduction in the circulation efficiency of the ejector 13.

### Second Embodiment

Next, a second embodiment will be described with a focus on differences from the first embodiment.

In this embodiment, when switching the nozzle used in the ejector 13 from the small nozzle 32 to the large nozzle 33, both the small nozzle 32 and the large nozzle 33 are used together for a predetermined time Δt. Herein, the predetermined time Δt is the time determined in consideration of the response of the small nozzle 32 from injection execution (use) to stop of injection (non-use) and the response of the large nozzle 33 from stop of injection (non-use) to injection execution (use).

This configuration can compensate a shortage of flow rate of fuel at the initial stage when the nozzle used in the ejector 13 is switched from the small nozzle 32 to the large nozzle 33, and thus the circulation efficiency of the ejector 13 can be improved.

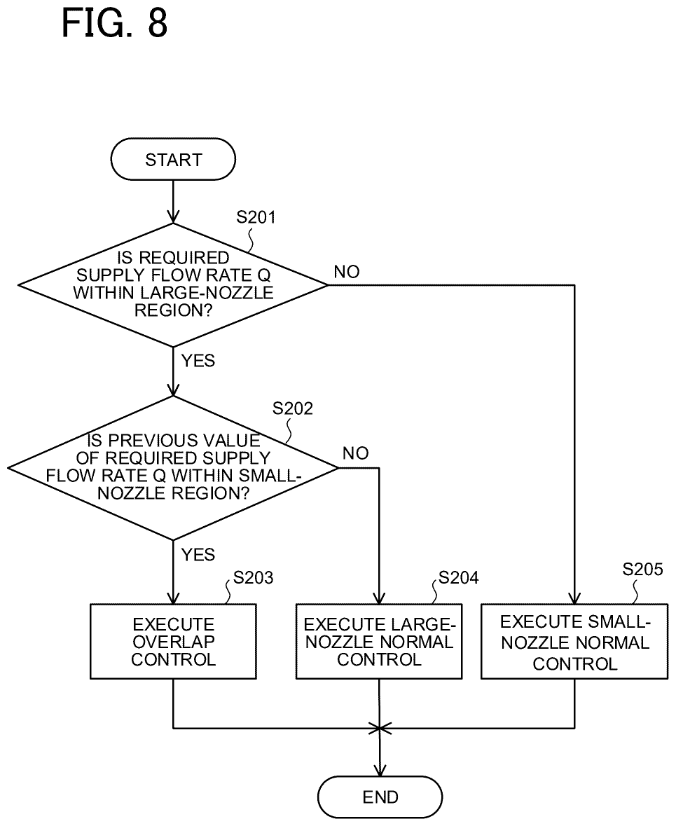

Specifically, the controller 19 performs the control whose details are described in FIG. 8. As shown in FIG. 8, the controller 19 first determines whether or not the required supply flow rate Q is within the large-nozzle region (step S201).

When the required supply flow rate Q is within the large-nozzle region (step S201: YES), the controller 19 determines whether or not a previous value of the required supply flow rate Q is within the small-nozzle region (step S202). The “previous value of a required supply flow rate Q” is a value of the required supply flow rate Q determined when the control shown in FIG. 8 is performed the last time.

When the previous value of the required supply flow rate Q is within the small-nozzle region (step S202: YES), the controller 19 executes the overlap control (step S203). Herein, the “overlap control” uses both the small nozzle 32 and the large nozzle 33.

On the other hand, when the previous value of the required supply flow rate Q is not within the small-nozzle region (step S202: NO), the controller 19 executes the large-nozzle normal control (step S204). Herein, the “large-nozzle normal control” uses only the large nozzle 33.

When the required supply flow rate Q is not within the large-nozzle region in step S101 (step S201: NO), the controller 19 executes the small-nozzle normal control (step S204). Herein, the “small-nozzle normal control” uses only the small nozzle 32.

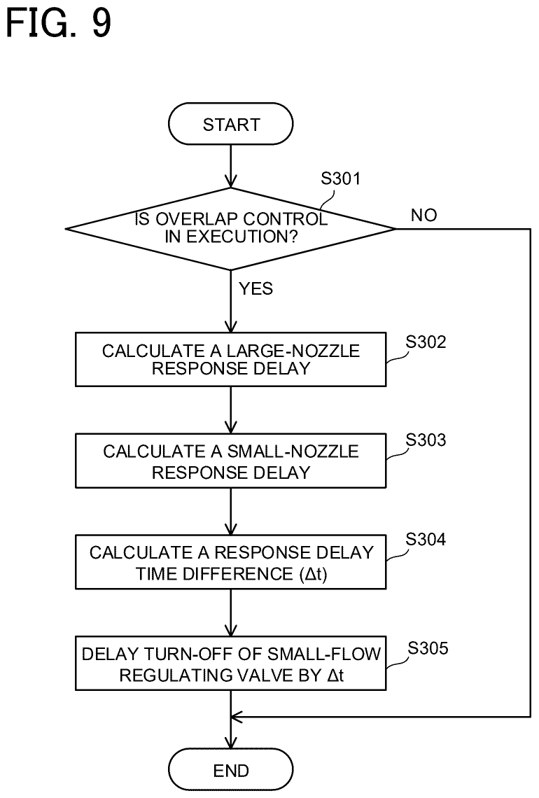

Further, the overlap control is performed as described in FIG. 9. As shown in FIG. 9, the controller 19 determines whether or not the overlap control is in execution (step S301).

When the overlap control is being executed (step S301: YES), the controller 19 calculates a large-nozzle response delay, which is a response delay from injection stop (non-use) to start of injection execution (use) of the large nozzle 33 (step S302), calculates a small-nozzle response delay, which is a response delay from injection execution (use) to injection stop (non-use) of the small nozzle 32 (step S303), and calculates a predetermined time Δt corresponding to a difference in response delay time between the large-nozzle response delay and the small-nozzle response delay (step S304). The controller 19 then delays the timing of turning off the small-flow regulating valve 14 by the predetermined time Δt (step S305). Thus, when switching the nozzle used in the ejector 13 from the small nozzle 32 to the large nozzle 33, both the small nozzle 32 and the large nozzle 33 are used for the predetermined time Δt.

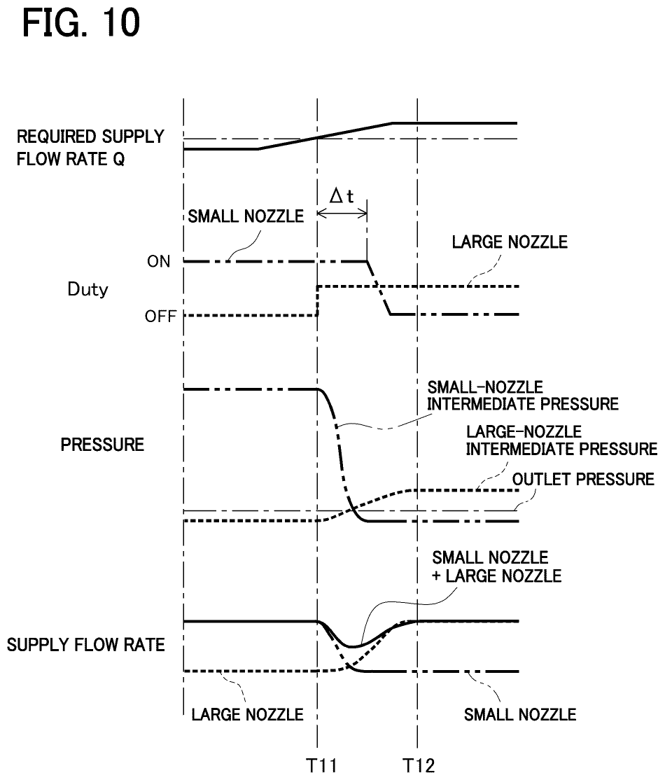

By executing the controls shown in FIG. 8 and FIG. 9, for example, the control shown in a time chart of FIG. 10 is performed as one example. As shown in FIG. 10, when the required supply flow rate Q (an FC required current) reaches a threshold and the nozzle used in the ejector 13 is switched from the small nozzle 32 to the large nozzle 33 (time T11), thereafter, the small nozzle 32 is continuously used as indicated by a broken line in the figure, and both the small nozzle 32 and the large nozzle 33 are used for the predetermined time Δt. This makes it possible to ensure a supply flow rate of fuel even in a period of time from T11 to T12, in which the flow rate would be insufficient conventionally. In FIG. 10, the “small-nozzle intermediate pressure” is the pressure at a position between the small-flow regulating valve 14 and the small nozzle 32, the large-nozzle intermediate pressure” is the pressure at a position between the large-flow linear solenoid valve 15 and the large nozzle 33, and the “outlet pressure” is the pressure at an outlet of the ejector 13.

The foregoing embodiments are mere examples and give no limitation to the present disclosure. The present disclosure may be embodied in other specific forms without departing from the essential characteristics thereof.

### REFERENCE SIGNS LIST

1 Fuel cell system
11 FC stack
12 Fuel supply passage
13 Ejector
16 Circulation passage
19 Controller
32 Small nozzle
33 Large nozzle
Q Required supply flow rate
th1 First flow rate
th2 Second flow rate
Δt Predetermined time

1. A fuel cell system including:
a fuel cell;
a fuel supply passage for supplying fuel to the fuel cell;
an ejector provided in the fuel supply passage;
a fuel supply unit for supplying the fuel to the ejector; and
a circulation passage for circulating the fuel that is unused in and discharged from the fuel cell to the ejector,
the fuel cell system being configured to supply the fuel to the fuel cell through the fuel supply passage via the ejector,
wherein the fuel cell system is configured to:
drive the fuel supply unit by pulse control when a required supply flow rate of the fuel for the fuel cell is smaller than a flow rate determined at a maximum circulation efficiency at which a circulation efficiency of the ejector is a maximum value when the fuel supply unit is driven by proportional control; and
drive the fuel supply unit by the proportional control when the required supply flow rate of the fuel for the fuel cell is equal to or larger than the flow rate determined at the maximum circulation efficiency.

2. The fuel cell system according to claim 1,
wherein the ejector includes, as a nozzle for injecting the fuel,
a first nozzle; and
a second nozzle that can inject the fuel with a larger flow rate than the first nozzle,
wherein the fuel supply unit includes:
a first fuel supply unit for supplying the fuel to the first nozzle; and
a second fuel supply unit for supplying the fuel to the second nozzle,
wherein the fuel cell system is configured to:
supply the fuel to the fuel cell using the first nozzle in a first supply region until the required supply flow rate of the fuel for the fuel cell reaches or nearly reaches a first flow rate which is a maximum flow rate during use of the first nozzle; and
supply the fuel to the fuel cell using the second nozzle in a second supply region where the required supply flow rate of the fuel for the fuel cell is larger than in the first supply region,
in the second supply region,
drive the second fuel supply unit by the pulse control when the required supply flow rate of the fuel for the fuel cell is smaller than the flow rate at the maximum circulation efficiency, and
drive the second fuel supply unit by the proportional control when the required supply flow rate of the fuel for the fuel cell is equal to or larger than the flow rate at the maximum circulation efficiency.

3. A fuel cell system including:
a fuel cell;
a fuel supply passage for supplying fuel to the fuel cell;
an ejector provided in the fuel supply passage; and
a circulation passage for circulating the fuel that is unused in and discharged from the fuel cell to the ejector,
the fuel cell system being configured to supply the fuel to the fuel cell through the fuel supply passage via the ejector,
wherein the ejector includes, as a nozzle for injecting the fuel,
a first nozzle; and
a second nozzle that can inject the fuel with a larger flow rate than the first nozzle,
when switching the nozzle used from the first nozzle to the second nozzle, both the first and second nozzles are used for a predetermined time.
